(19) United States
(12) Patent Application Publication
(10) Pub. No.: US 2013/0313755 A1
(43) Pub. Date: Nov. 28, 2013

(54) DEVICE AND METHOD FOR TREATING A CERAMIC WORKPIECE

(71) Applicant: Jürgen Gegner, Forchheim (DE)

(72) Inventor: Jürgen Gegner, Forchheim (DE)

(21) Appl. No.: 13/988,155

(22) PCT Filed: Nov. 18, 2011
(86) PCT No.: PCT/EP2011/070432

§ 371 Date: Aug. 15, 2013

(30) Foreign Application Priority Data
Nov. 19, 2010 (DE) 10 2010 044 171.6

(51) Int. Cl. B29C 71/00

(52) U.S. Cl. CPC B29C 71/00
USPC 264/340; 425/445

(57) ABSTRACT

A device and method for treating a workpiece that is formed completely, or at least in a region of the surface to be treated, of a ceramic material. The device and method utilize a treatment element configured to transmit a substantially shock-free contact force to a surface of the workpiece to generate or increase compressive residual stresses in the workpiece.

The present invention relates to the mechanical treating of workpieces or components, which have a ceramic material completely or at least in the region of to-be-treated surface.

It is known from the field of conventional technology that ceramic materials, which are used for example for components in machine and automobile construction, disadvantageously distinguish themselves by their brittleness and low ductility (high inner sliding resistance). Depending on the tensile stress, in many cases a failure results, which usually emanates from the material surface. The static and dynamic strength (e.g. with respect to rolling fatigue) of this material is limited.

Ceramic materials distinguish themselves by a high hardness, strength, and stiffness. The important structural ceramics primarily include aluminum oxide, silicon carbide, silicon nitride, and zirconium oxide. Silicon nitride and Silicon carbide are used in particular for example in the manufacture of rolling-element or sliding bearings. In addition to low wear, they have a high temperature- and corrosion-resistance.

During the operation of a component, the material boundary layer is usually stressed the most. A method for increasing the boundary layer strength on surfaces of workpieces made from brittle materials is known from DE 196 52 872 C 2. Here the workpiece surface is brought into contact with a tool in narrowly defined surface regions, which tool, without ablating material, plastically deforms the surface region and generates compressive residual stresses close to the surface inside the workpiece. In order to achieve this, a blasting with balls is proposed, which are driven onto the workpiece surface using a compressed-air-driven or centrifugal-wheel-driven blasting system, in order to achieve a plastic deformation of the surface, without so-called brittle fractures occurring. This shows that even ceramics have sufficient plastic deformability to make possible the mechanical generation of compressive residual stresses in the boundary layer.

Furthermore, the use of costly high-performance ceramics is known in the context of the state of the prior art for highly-stressed components, such as hot (isostatic) pressed silicon nitride, which is used for example for components required to withstand fatigue, such as rolling-element bearings. Alternatively, from the literature for the use of more economical ceramic materials, methods are also known for generating compressive residual stresses in the close-to-the-surface boundary layer of workpieces. Here reference is made to shot peening or ion implantation.

A disadvantage of the shot peening method is that the blast stream must be set such that a threshold for the occurrence of brittle fracture of the material is not exceeded, which narrows the available process window. In processes which use compressed air or another medium for generating the blast stream and for acceleration of balls or particles, an exact setting of the momentum transfer to the material is not possible due to the statistical distribution of the particles in the blast stream. The particles differ from one another to some extent with respect to their shape, mass, and speed, so that a statistical distribution also results with respect to their momenta. In order to not exceed the breaking point of the material, a certain safe distance from this threshold is observed, with the result that the stabilizing effect due to the increase in compressive residual stresses cannot be fully utilized.

It is therefore the object of the present invention to provide an improved concept for mechanically treating workpieces or components which have a ceramic material completely or at least in the region of the surface to be treated.

The object is achieved by a device and a method according to the independent claims.

A core concept of the present invention lies in a device for mechanically treating a workpiece or component, which has a ceramic material completely or at least in the region of the surface to be treated, with a treatment element which is formed to transmit a substantially shock-free contact force onto a surface of the workpiece, and to generate or to increase compressive residual stresses in the workpiece which has the ceramic material. The workpiece or the component can thus have, completely or partially, a ceramic, part-ceramic, or a composite material. Preferably, the treatment element has a greater hardness than the to-be-treated ceramic, or the surface of the to-be-treated workpiece or component. The contact force is set sufficiently high that a plastic deformation results in the ceramic or in the workpiece or component. The treatment parameters are selected such that crack formation is completely avoided, or at least only occurs to a non-critically small extent for the application of the workpiece or component.

It is a core concept of exemplary embodiments of the present invention to introduce, as shock-free as possible, or nearly shock-free, mechanically-generated compressive residual stresses into the surface and the near-the-boundary material zones of workpieces or components which have ceramic materials. This based, among other things, on the recognition that with a shock-free force transmission, especially brittle materials, such as for example ceramics, can be processed or treated closer to the breaking point (brittle breaking point). The contact force is settable in a more defined manner by a shock-free or nearly shock-free treatment or processing than for example with peening methods. Ceramic materials in particular can thereby be treated or processed closer to their breaking points, and an improved stability can be achieved overall.

In the present description, “shock-free” or “nearly shock-free” are understood to mean that no substantial momentum transfer from the treatment tool to the workpiece occurs. In other words, the contact force is indeed transferred to the surface of the workpiece, however this occurs largely “momentum-free” or shock-free. Here a shock, a momentum or even energy is transferred from the treatment element to the workpiece insofar as the surface of the workpiece yields to the contact force of the treatment element. The treatment element has essentially no momentum relative to the workpiece, and also no relative speed.

A roller element can be used as treatment element in exemplary embodiments. For this purpose the roller element (for example ball, tapered roller, roller, cylinder) can roll under sufficiently high contact pressure on the to-be-treated surface of the component or workpiece. Here the surface of the workpiece can advantageously be simultaneously smoothed, for example by breakage of asperities.

Exemplary embodiments of the present invention are explained in the following in more detail with reference to the accompanying Figures.

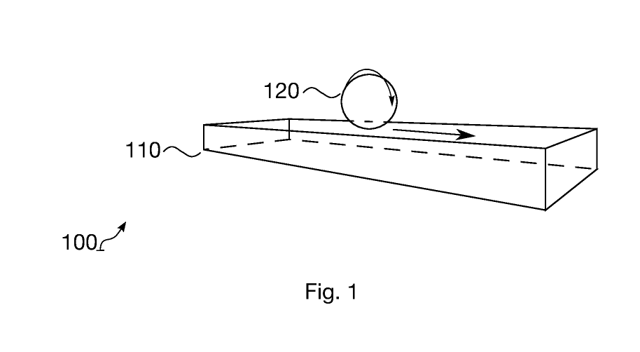

FIG. 1 shows an exemplary embodiment of a device for treating a workpiece or component; and

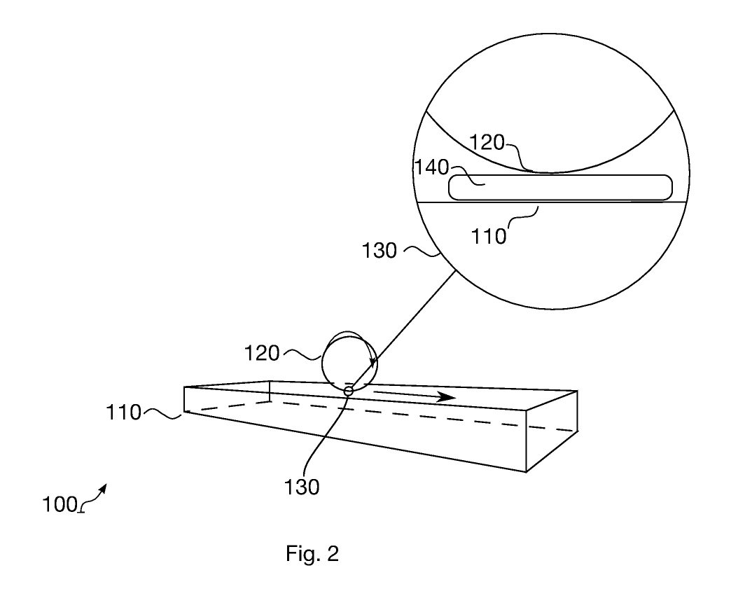

FIG. 2 shows a further exemplary embodiment of a device for treating a workpiece or component.

FIG. 1 illustrates a device 100 for treating a workpiece/component 110, wherein the workpiece/component 100 has a ceramic material, the device 100 having a treatment element 120, which is formed to transmit a substantially shock-free contact force onto a surface of the workpiece/component 110, and to generate or increase compressive residual stresses in the workpiece/component 110 which has the ceramic material.

The treatment 120 can have greater hardness than the to-be-treated ceramic material of the workpiece/component 110.

The device 100 can further include an appropriate retaining means or clamping means for fixing the workpiece 110. The retaining means can be formed to exert no force on the workpiece 110, which force is above the brittle breaking point of the workpiece.

Accordingly, a retaining device can include, for example, appropriate jaws, or can be generally formed not to exceed a predefined force on the workpiece 110.

Here the substantially shock-free or momentum-free transmission is to be understood such that the transmission can also occur completely shock-free. As is explained in more detail in the following, different treatment elements 120 can be considered, wherein a momentum transfer cannot always be avoided, in particular during placement. However, the actual treatment can take place in a shock-free manner.

Exemplary embodiments therefore carry out a method for developing compressive residual stresses in a workpiece 110, wherein the workpiece 110 has a ceramic material. The method comprises a step of substantially shock-free contacting of a treatment element 120 and a step of the transferring of a contact force to a surface of the workpiece 110. In other words, the contacting can occur with a constant or nearly constant force.

In exemplary embodiments, the treatment element 120 can be formed as roller element 120, which transmits the contact force to the surface of the workpiece 110 during the rolling. Accordingly, the contacting can be generated by rolling by a relative movement between the workpiece 110 and the roller element 120. The contact force can then be transmitted by rolling and thus be held substantially constant. The roller element 120 can for example be formed as a ball or as a roller. FIG. 1 here exemplarily shows a treatment element 120 which is formed in ball-like shape. In principle, any shapes for the roller element 120 are conceivable in exemplary embodiments having roller elements 120, provided they are suitable for rolling, or substantially suitable for rolling, such as e.g. balls, rollers, tapered rollers, etc. In the corresponding method a step of substantially shock-free setting a ball or a roller on the workpiece 110 can therefore also be provided.

Exemplary embodiments here do not exclude the occurrence of slippage between the roller element 120 and the surface of the workpiece 110. In other words, it can be provided in exemplary embodiments that the treatment element 120 both exerts the contact force on the surface of the workpiece 110, and brings about a smoothening effect. The smoothening effect can be brought above for example by ablation (abrasive) or by breakage of the asperities on the surface. A grinding effect can additionally be brought about by the treatment element 120. In other words, in exemplary embodiments having direct contact between the treatment element 120 and the surface of the workpiece 110, a smaller material ablation can be provided, e.g. by breakage of asperities (so that a smoothening of the surface is optionally associated).

In exemplary embodiments, the treatment element 120 can have a ceramic and/or a metallic material. Metal (e.g. high-strength steel), ceramic (e.g. shot-peened silicon nitride), or a composite material (e.g. cemented carbide: such as WC/Co) can be used as treatment/roller-element material. The component/workpiece 110 can in particular be comprised of polymer-derived ceramic and have a specific metallic content. The to-be-treated (functional) surface can be ground, and after the treatment/rolling treatment, can be surface-treated or -processed with slight material ablation (e.g. honed) for setting a desired roughness, or can be directly used without further final processing or final treatment.

In exemplary embodiments the device 100 can further include an apparatus for carrying out a relative movement between the workpiece 110 and the treatment element 120. According to the exemplary embodiments already described above, this relative movement can provide a rolling of the treatment element 120. However, in other exemplary embodiments a kneading relative movement between the treatment element 120 and the surface of the workpiece 110 can result, wherein rolling need not necessarily be provided here. In this case, exemplary embodiments are not limited to a specific movement sequence of the relative movement. The relative movement can for example proceed circularly, sinus-wave-shaped, sawtooth-shaped, or similarly. For this purpose the treatment tool 120 can move and the workpiece 110 can be held stationary. It is also conceivable to hold the treatment tool 120 stationary and to move the workpiece 110. In further exemplary embodiments it is conceivable that both the treatment tool 120 and workpiece 110 move. In other words, in exemplary embodiments either the roller element 120 or the component 110 or even both can be moved (rotated) to realize the relative movement. A plurality of treatment elements/roller elements 120 having the same or different diameters can also be used, and they can be rolled in an integrated treatment tool together simultaneously or even repeatedly in a single-element device 100 after temporally-successively exchanging, each with (nearly) constant or purposefully varying contact force, in order to achieve the desired compressive residual stress development (maximum, depth). An assessment of the effect(s) for the same or varying treatment element diameters and/or contact pressures enables the calculation of the depth distribution(s) of the von Mises yield criterion for the respective Hertzian contact(s).

Exemplary embodiments can therefore comprise a device 100 or a method, wherein a step of contacting or rolling is performed once or repeatedly, simultaneously or sequentially with one or more treatment- or roller elements 120 of the same or varying diameters with constant, nearly constant or purposely varying contact force.

The device 100 can be formed to transmit the contact force of the treatment element 120 by direct contact with the surface of the workpiece 110. This method is illustrated in FIG. 1. The contact force is transmitted directly from the treatment element 120 to the surface of the workpiece 110.

A further embodiment is shown in FIG. 2. FIG. 2 first shows the same exemplary embodiment as FIG. 1, thus the device 100, the workpiece/component 110, and the treatment element 120. In contrast to the exemplary embodiment of FIG. 1, in FIG. 2 an intermediate material 140 is located between the surface of the workpiece 110 and the treatment element 120. This is indicated in FIG. 2 by the enlarged region 130. In this exemplary embodiment, the contact force is transmitted from the intermediate material 140 to the surface of the workpiece 110, wherein the intermediate material can be solid, liquid, or gaseous, and the contact force is transmitted from the treatment element 120 to the intermediate material 140. An advantage of the exemplary embodiment shown in FIG. 2 is that with rolling treatment of the intermediate material 140, the friction and thus energy losses in contact can be reduced, which intensifies the desired compressive residual stress development in the workpiece/component 110.

In exemplary embodiments, the device 100 can be formed to transmit the contact force of the treatment element 120 by indirect contact with a surface of the workpiece 110. The increase of the compressive residual stresses in the surface of the workpiece 110 can thus occur without direct contact of the roller element 120 and the component surface 110, by using an appropriate (e.g. liquid) intermediate material 140. The intermediate material 140 here can be solid, liquid, or gaseous.

Exemplary embodiments can also thus provide to repeatedly perform the step of rolling. Accordingly, exemplary embodiments can comprise a method for mechanical surface treatment, wherein surfaces of ceramic materials and components 110 are treated or processed. In this case, the surface can be subjected to compressive residual stresses by one-time or repeated, simultaneous or sequential rolling of one or more rolling elements 120, of the same or different diameter, either without direct contact via a gaseous, liquid, or solid intermediate material 140, or in direct contact with small or negligible material ablation by a (nearly) constant or purposefully varying contact force.

The static and dynamic strength (e.g. indentation resistance or rolling strength) can be increased by the generated compressive residual stresses. The fatigue service life of a cyclically-loaded ceramic component increases. The benefits are demonstrated in terms of mechanical fracture, by including compressive residual stresses as residual stresses of the 1st type as load stresses in the stress intensity factor, which corresponds to an increase in toughness (resistance to crack development). For example, ceramic rolling-element bearing roller elements (e.g. cylindrical rollers) or rolling-element bearing rings can be treated in order to increase the service life of the bearing. The wear resistance also increases. It appears especially useful to inventively treat less-expensive types of ceramics (e.g. polymer-derived ceramics, aluminum oxide), in order to thus strengthen the surface layer, which is highly stressed in operation, with a cost-effective method.

### REFERENCE NUMBER LIST

100 Device for treating a workpiece

110 Workpiece

120 Treatment element

130 Enlarged region

140 Intermediate material

1. A device for treating a workpiece with a treatment element, wherein the workpiece has a ceramic material completely or at least in the region of the surface to be treated, which treatment element is formed to transmit a substantially shock-free contact force onto a surface of the workpiece, and to generate or to increase compressive residual stresses in the workpiece which has the ceramic material, wherein
the device is formed to transmit the contact force of the treatment element by indirect contact with a surface of the workpiece via an intermediate material.

2. The device according to claim 1, wherein the treatment element is formed as a roller element which transmits the contact force to the surface of the workpiece during rolling.

3. The device according to claim 2, wherein the rolling element is formed as a ball or as a roller.

4. The device according to claim 1, wherein the treatment element has a ceramic and/or a metallic and/or composite material.

5. The device according to claim 1, which further has an apparatus for carrying out a relative movement between the workpiece and the treatment element.

6. (canceled)

7. A method for increasing the compressive residual stress of a workpiece, wherein the workpiece has a ceramic material completely or at least in the region of the surface to be treated, by substantially shock-free contact of a treatment element; and transmitting a contact force to a surface of the workpiece, wherein
the contact force is transmitted from an intermediate material to the surface of the workpiece, wherein the intermediate material is solid, liquid, or gaseous, and the contact force is transmitted from the treatment element to the intermediate material.

8. (canceled)

9. The method according to claim 7, wherein the treatment element is a roller element and the contacting is generated by rolling by a relative movement between the workpiece and the roller element.

10. The method according to claim 6, wherein the contacting or rolling is performed one-time or repeatedly, simultaneously or sequentially, with one or more treatment- or roller elements of the same or different diameter, with constant, nearly constant, or purposefully varying contact force.

11. The device according to claim 1, including a clamp for clamping the treatment element against the surface of the surface of the workpiece.

12. The device according to claim 11, wherein the clamp includes jaws.

13. The device according to claim 11, wherein the clamp is configured to prevent the exertion of forces above a maximum force on the workpiece, the maximum force being selected to be less than a brittle breaking point force of the workpiece.

14. A method for increasing compressive residual stresses of a workpiece having a ceramic material at least in a region of a surface to be treated, the method comprising:
placing an intermediate material on the surface to be treated;
placing a treatment element into contact with the intermediate material in a substantially shock-free manner; and
using the treatment element to transmit a contact force to the surface of the workpiece via the treatment element to increase the compressive residual stresses of the workpiece.

15. The method according to claim 14 including:
determining a brittle breaking force for the ceramic material; and
preventing the contact force from exceeding the brittle breaking force.

16. The method according to claim 13 including performing a kneading relative movement between the treatment element and the surface.
